(19) United States
(12) Patent Application Publication
(10) Pub. No.: US 2025/0157012 A1
(43) Pub. Date: May 15, 2025

(54) EXPANSION FUNCTION SELECTION IN AN INVERSE TONE MAPPING PROCESS

(71) Applicant: InterDigital CE Patent Holdings, SAS, Paris (FR)

(72) Inventors: Patrick Lopez, Livre sur Changeon (FR); Laurent Cauvin, Chevaigne (FR); Frederic Plissonneau, Thorigne-Fouillard (FR); Guillaume Poirier, Rennes (FR)

(21) Appl. No.: 18/729,732

(22) PCT Filed: Jan. 3, 2023
(86) PCT No.: PCT/EP2023/050076

§ 371 Date: Jul. 17, 2024

(30) Foreign Application Priority Data
Jan. 19, 2022 (EP) 22305053.5

(51) Int. Cl. G06T 5/92; G06T 5/40; G06T 5/50

(52) U.S. Cl. CPC G06T 5/92; G06T 5/40; G06T 5/50; G06T 2207/20208

(57) ABSTRACT

A method comprising: obtaining an histogram of a current SDR picture, the histogram comprising bins, a bin associating a sample value to a number of occurrences of the sample value in the current SDR picture; determining a current state value representative of the current SDR picture from at least one most representative bin of the histogram, the most representative bin being the bin of the histogram representing the highest number of samples of the current SDR picture; identifying a profile in a set of a plurality of profiles corresponding to the determined current state value, each profile of the plurality being associated to an expansion function; and, applying an inverse tone mapping to the current SDR picture using the expansion function associated with the identified profile to obtain a HDR picture.

### 1. TECHNICAL FIELD

At least one of the present embodiments generally relates to the field of production of High Dynamic Range (HDR) video and more particularly to a method, a device and an equipment for expanding a dynamic range of low or standard dynamic range (LDR or SDR) pictures, with a specific focus on how to define an expansion function.

### 2. BACKGROUND

Recent advancements in display technologies are beginning to allow for an extended dynamic range of color, luminance and contrast in pictures to be displayed. The term picture refers here to a picture content that can be for example a picture of a video or a still picture.

High-dynamic-range video (HDR video) describes video having a dynamic range greater than that of standard-dynamic-range video (SDR video). HDR video involves capture, production, content/encoding, and display. HDR capture and display devices are capable of brighter whites and deeper blacks than SDR capture and display devices. To accommodate this, HDR encoding standards allow for a higher maximum luminance and use at least a 10-bit dynamic range (compared to 8-bit for non-professional and 10-bit for professional SDR video) in order to maintain precision across this extended range.

HDR production is a new domain and there will be a transition phase during which both HDR contents and SDR contents will coexist. During this coexistence phase, a same live content will be produced simultaneously in a HDR and a SDR version.

HDR contents can be obtained by applying an inverse tone mapping (ITM) to a SDR/LDR content. To achieve more extreme increases of dynamic ranges, many ITM processes combine a global expansion of the luminance with local processing steps that enhance the appearance of highlights and other bright regions of pictures.

In some ITM solutions, the local processing is based on an expansion map (or an expansion function) which defines for each pixel of a picture, an exponent to be applied to the luminance value of this pixel during the ITM process.

The document EP3249605 discloses a method adapting an expansion function to a picture content. In this method, several profiles are defined offline in a learning phase. Each profile is defined by a picture feature such as an histogram of luminance values and associated to an expansion function adapted to this profile. When a current picture is to be inverse tone mapped, its picture feature is compared to the picture feature of each profile, and the profile having the picture feature the closest to the picture feature of the current picture is selected. The expansion function of the selected profile is then applied to the current picture.

With this method, when a video content is changing slowly, it may happen that the profiles selected along the sequence of picture generate moderate variations of the expansion functions, resulting in unpleasant variations between consecutive HDR pictures.

It is desirable to overcome the above drawbacks.

It is particularly desirable to propose a method which attenuates the differences between the expansion functions applied on consecutive SDR pictures when a video content is changing slowly.

### 3. BRIEF SUMMARY

In a first aspect, one or more of the present embodiments provide a method comprising:
obtaining a first histogram of a current SDR picture, the first histogram comprising a first number of bins, a bin associating a sample value to a number of occurrences of the sample value in the current SDR picture;
determining a current state value representative of the current SDR picture from at least one most representative bin of the first histogram, the most representative bin being the bin of the first histogram representing a highest number of samples of the current SDR picture;
identifying a profile in a set of a plurality of profiles corresponding to the determined current state value, each profile of the plurality being associated to an expansion function; and,
applying an inverse tone mapping to the current SDR picture using the expansion function associated with the identified profile to obtain a HDR picture.

In an embodiment, the first histogram is obtained from a second histogram of the current SDR picture comprising a second number of bins, the first number of bins being less than the seconds number of bins.

In an embodiment, the current state value is further determined from at least one second most representative bin of the first histogram, the second most representative bin being a bin of the first histogram different from the most representative bin representing one of the highest number of samples of the current SDR picture.

In an embodiment, the method comprises determining if a transition between a previous state value and the current state value, the previous state value being representative of a previous SDR picture preceding the current SDR picture, belongs to a set of allowed transitions and, responsive to the transition not belonging to the set of allowed transitions, determining at least one intermediate state value from the set of allowed transitions, identifying a first profile in the set of a plurality of profiles corresponding to a first determined intermediate state value; and, applying an inverse tone mapping to the current SDR picture using an expansion function associated to the identified first profile to obtain the HDR picture.

In an embodiment, when at least one second intermediate state value is determined from the set of allowed transitions, identifying a second profile in the set of a plurality of profiles for each second determined intermediate state value; and, applying an inverse tone mapping to SDR pictures following the current SDR picture using expansion functions associated to the identified second profiles to obtain the HDR pictures.

In an embodiment, the expansion function used for the inverse tone mapping of the current SDR picture is based on the expansion function associated to the profile identified using the current state value and at least one expansion function determined for a SDR picture preceding the current SDR picture.

In a second aspect, one or more of the present embodiments provide a device comprising electronic circuitry configured for:
obtaining a first histogram of a current SDR picture, the first histogram comprising a first number of bins, a bin associating a sample value to a number of occurrences of the sample value in the current SDR picture;
determining a current state value representative of the current SDR picture from at least one most representative bin of the first histogram, the most representative bin being the bin of the first histogram representing a highest number of samples of the current SDR picture;
identifying a profile in a set of a plurality of profiles corresponding to the determined current state value, each profile of the plurality being associated to an expansion function; and,
applying an inverse tone mapping to the current SDR picture using the expansion function associated with the identified profile to obtain a HDR picture.

In an embodiment, the first histogram is obtained from a second histogram of the current SDR picture comprising a second number of bins, the first number of bins being less than the second number of bins.

In an embodiment, the current state value is further determined from at least one second most representative bin of the first histogram, the second most representative bin being a bin of the first histogram different from the most representative bin representing one of the highest number of samples of the current SDR picture.

In an embodiment, the electronic circuitry is further configured for determining if a transition between a previous state value and the current state value, the previous state value being representative of a previous SDR picture preceding the current SDR picture, belongs to a set of allowed transitions and, responsive to the transition not belonging to the set of allowed transitions, determining at least one intermediate state value from the set of allowed transitions, identifying a first profile in the set of a plurality of profiles corresponding to a first determined intermediate state value; and, applying an inverse tone mapping to the current SDR picture using an expansion function associated to the identified first profile to obtain the HDR picture.

In an embodiment, the electronic circuitry is further configured, when at least one second intermediate state value is determined from the set of allowed transitions, for identifying a second profile in the set of a plurality of profiles for each second determined intermediate state value; and, applying an inverse tone mapping to SDR pictures following the current SDR picture using expansion functions associated to the identified second profiles to obtain the HDR pictures.

In an embodiment, the expansion function used for the inverse tone mapping of the current SDR picture is based on the expansion function associated to the profile identified using the current state value and at least one expansion function determined for a SDR picture preceding the current SDR picture.

In a third aspect, one or more of the present embodiments provide a signal generated using the method of the first aspect or by using the device of the second aspect.

In a fourth aspect, one or more of the present embodiments provide a computer program comprising program code instructions for implementing the method of the first aspect.

In a fifth aspect, one or more of the present embodiments provide a non-transitory information storage medium storing program code instructions for implementing the method of the first aspect.

### 4. BRIEF SUMMARY OF THE DRAWINGS

FIG. 1 illustrates schematically a context of various embodiments;

FIG. 2A illustrates schematically an example of hardware architecture of a processing module able to implement various aspects and embodiments;

FIG. 2B illustrates a block diagram of an example of a first system in which various aspects and embodiments are implemented;

FIG. 2C illustrates a block diagram of an example of a second system in which various aspects and embodiments are implemented;

FIG. 3 illustrates an inverse tone mapping process;

FIG. 4 illustrates schematically a first example of a process for determining an expansion function;

FIG. 5 illustrates schematically a second example of a process for determining an expansion function;

FIG. 6A illustrates an example of uniform bin reduction; and,

FIG. 6B illustrates an example of non-uniform bin reduction.

### 5. DETAILED DESCRIPTION

As mentioned earlier, to enhance bright local features in a picture, it is known to create a luminance expansion map, wherein each pixel of the picture is associated with an expansion value to apply to the luminance of this pixel. In a simple approach, clipped regions in the picture can be detected and then expanded using a steeper expansion curve. However such a solution does not offer sufficient control over the appearance of the picture.

A more controllable luminance expansion solution is given in the patent application WO2015/096955 which discloses a method comprising, for each pixel p of a picture, the steps of obtaining a pixel expansion exponent value E(p) and then inverse tone mapping the luminance Y(p) of the pixel p into an expanded luminance value Yₑₓₚ(p) by using the following equation:

$${Y}_{exp} ( p ) = {Y ( p )}^{E ( p )} * [ {Y}_{enhance} ( p ) ]$$

where:
   Yₑₓₚ(p) is the expanded luminance value of the pixel p.
   Y(p) is the luminance value of the pixel p within the SDR (or LDR) input picture.
   Y_{enhance}(p) is a luminance enhancement value for the pixel p within the SDR (or LDR) input image.
   E(p) is a pixel expansion exponent value for the pixel p.

The pixel expansion exponent values E(p) for all pixels of a picture form an expansion exponent map, or “expansion map”, for the picture. This expansion map can be generated by different methods, for example by low-pass filtering the luminance value Y(p) of each pixel p to obtain a low-pass filtered luminance value Y_{base}(p) and applying a quadratic function to the low-pass filtered luminance value Y_{base}(p), said quadratic function being defined by parameters a, b and c according to the following equation:

$$E ( p ) = {a [ {Y}_{base} ( p ) ]}^{2} + b [ {Y}_{base} ( p ) ] + c$$

The document ITU-R BT.2446-1 describes a method for converting SDR contents to HDR contents by using a similar formula:

Y′_{HDR}=Y″^{E}
Wherein
   Y′ is in the range [0 . . . 1];
   Y″=255.0×Y′;
   E=a₁Y″²+b₁Y″+c₁ when Y″≤T;
   E=a₂Y″²+b₂Y″+c₂ when Y″>T;
   T=70;
   a1=1.8712e-5, b1=−2.7334e-3, c1=1.3141;
   a2=2.8305e-6, b2=−7.4622e-4, c2=1.2528.

In all these applications, the expansion function is based on a power function whose exponent depends on the luminance value of the current pixel, or on a filtered version of this luminance value.

More generally, all ITM methods based on a global expansion in which all pixels having a same luminance value in the SDR picture have a same expanded value in the HDR picture (as in the method of document ITU-R BT.2446-1) can be expressed in the following way:

$${Y}_{HDR} = {Y}^{G ( Y )} \qquad ( 1 )$$

for all input values different from zero (for zero at the input, the output is logically also zero).

Similarly, all ITM methods based on a local expansion can be expressed in the following way (if, as above Y is different from zero):

$${Y}_{HDR} = {Y}_{F}^{G ( {Y}_{F} )} {Y}_{enhance} ( Y , {Ys}_{i} ) \qquad ( 2 )$$

whereas Y_{F} is a filtered version of Y, G is an expansion function of Y_{F} and Y_{enhance} is a function of Y and its neighboring pixels Ysᵢ.

In both cases (global or local), the expansion function must be monotonic, in order to be consistent with the input SDR picture.

Some ITM methods use an expansion function G based on predetermined expansion parameters (as described for example in the document ITU-R BT.2446-1) without any adaptation to the original video or picture content. Document EP3249605 discloses a method for inverse tone mapping of a picture that can adapt automatically to a picture content to inverse tone-map. The method uses a set of profiles forming a template. These profiles are determined in a offline learning phase. Each profile is defined by a visual feature, such as an histogram of luminance values, to which an expansion function (i.e. an expansion, map) is associated. In the learning phase, the profiles are determined from a large number of reference pictures that are manually graded by colorists, who manually set ITM parameters and generate the expansion functions for these pictures. Then, the reference pictures are clustered based on these generated expansion functions. Each cluster is processed in order to extract a representative histogram of luminance values and a representative expansion function associated thereto, thus forming a profile issued from said cluster. When a new SDR content is obtained, an histogram of luminance values is computed for pictures of this new SDR content. The computed histogram is compared to each of the histograms saved in the template, issued from the learning phase, in order to find the best match histogram of the template, i.e. in order to find the profile corresponding to the new SDR content. For example, a distance between the computed histogram and each of the histograms saved in the template is calculated. Then the expansion function corresponding to the histogram (i.e. the profile) giving the best match is selected. This selected expansion function is then used to inverse tone map the picture of the new SDR content and to obtain corresponding HDR pictures. In this way, the best expansion function of the template is applied to output the HDR pictures.

When the content of consecutive pictures is changing slowly, it may happen that the profiles chosen along the sequence of pictures generate moderate variations of the expansion function, resulting in artificial changes in consecutive HDR pictures and, consequently, in an altered perception of the HDR picture.

To solve the above problem, it is proposed in the following various embodiments of a method allowing attenuating the differences between the expansion functions (or equivalently between the expansion maps) applied on consecutive SDR pictures when the histograms of consecutive SDR pictures is evolving slowly and therefore, avoiding unpleasant variations in the corresponding HDR pictures.

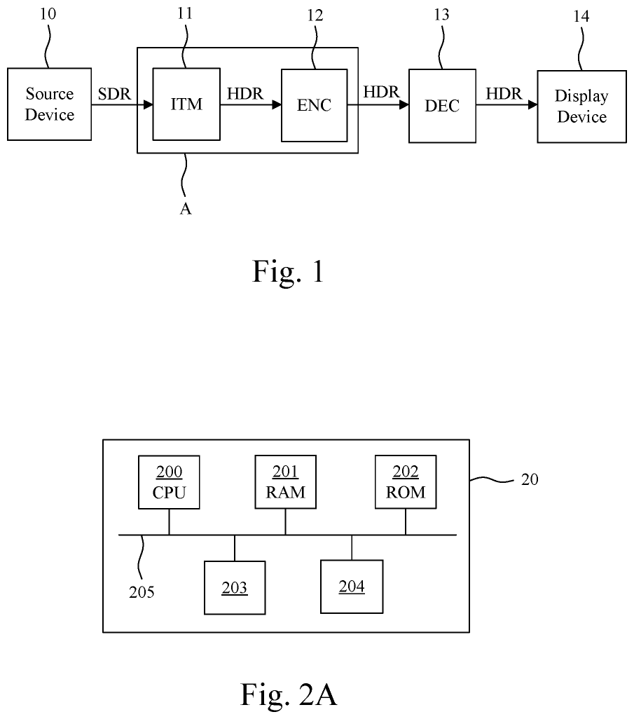

FIG. 1 illustrates an example context in which the various embodiments are implemented.

In FIG. 1, a source device 10, such as a SDR camera or a streaming system providing a SDR video content, provides a SDR video content to a system A. The system A comprises a ITM module 11 and a video encoder 12. The ITM module 11 generates a HDR video content from the SDR video content using a method of this document. The HDR content is then encoded by the video encoder 12 in a bitstream using a video compression format such as AVC ((ISO/CEI 14496-10/ITU-T H.264), HEVC (ISO/IEC 23008-2—MPEG-H Part 2, High Efficiency Video Coding/ITU-T H.265)), VVC (ISO/IEC 23090-3—MPEG-I, Versatile Video Coding/ITU-T H.266), AV1, VP9, EVC (ISO/CEI 23094-1 Essential Video Coding) or any other video compression format adapted to encode HDR contents.

The system A then provides the bitstream to a video decoder 13 for instance via a network. The video decoder 13 is adapted to decode the bitstream generated by the video encoder 12.

The decoder HDR video content is then provided to a display device adapted to display HDR contents such as a PC, a TV, a smartphone, a tablet or a head mounted display.

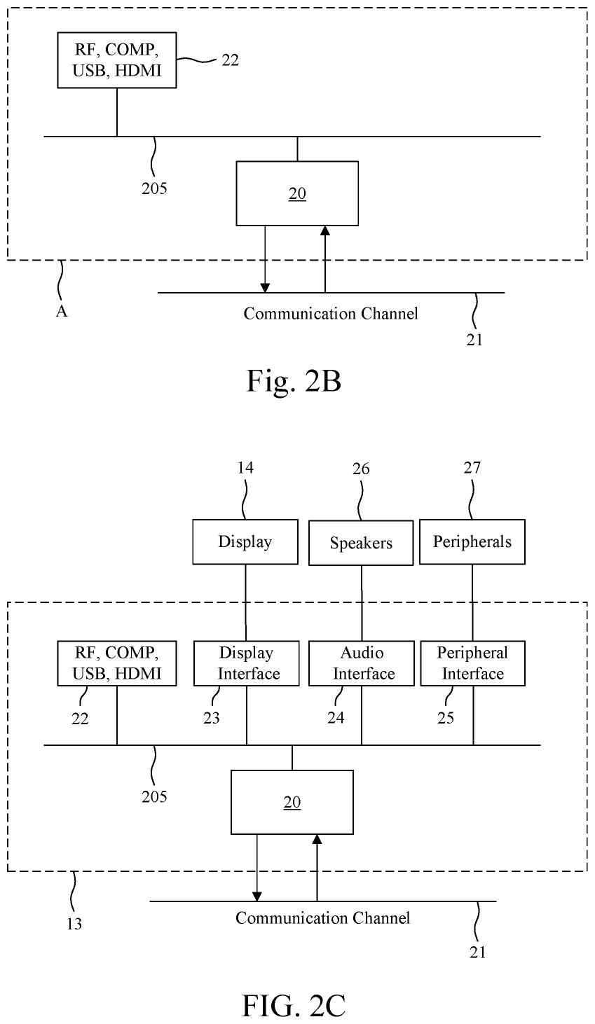

FIG. 2A illustrates schematically an example of hardware architecture of a processing module 20 comprised in the ITM module 11, in the video encoder 12, in the system A or in the video decoder 13. The processing module 20 comprises, connected by a communication bus 205: a processor or CPU (central processing unit) 200 encompassing one or more microprocessors, general purpose computers, special purpose computers, and processors based on a multi-core architecture, as non-limiting examples; a random access memory (RAM) 201; a read only memory (ROM) 202; a storage unit 203, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 204 for exchanging data with other modules, devices, systems or equipment. The communication interface 204 can include, but is not limited to, a transceiver configured to transmit and to receive data over a communication network 21. The communication interface 204 can include, but is not limited to, a modem or a network card.

For example, the communication interface 204 enables the processing module 20 to receive SDR data and to output HDR data.

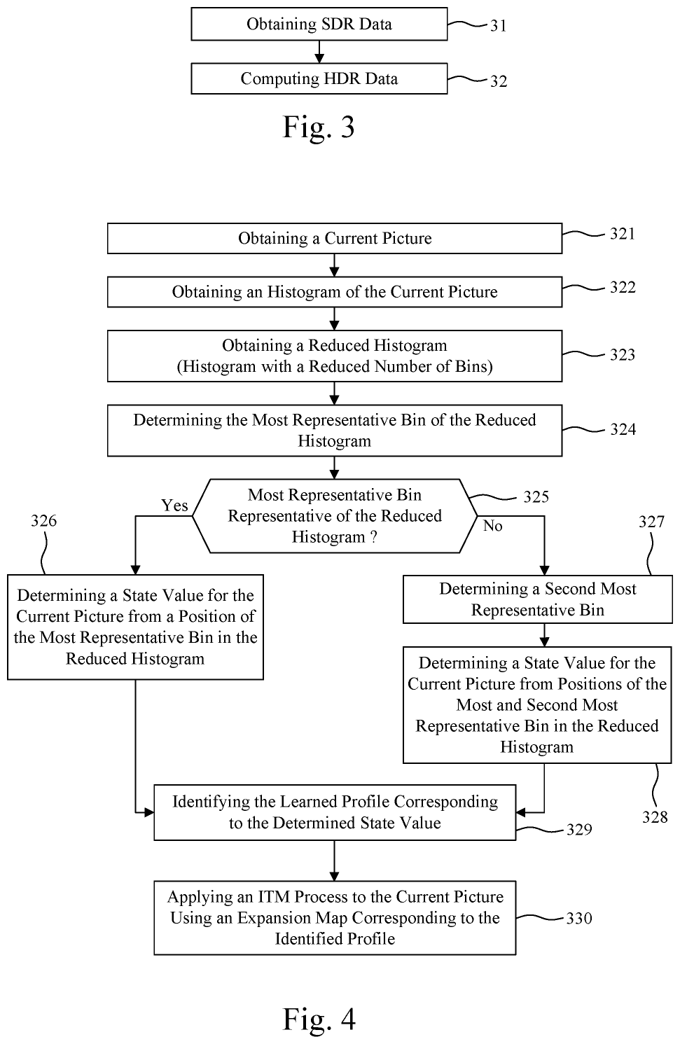

The processor 200 is capable of executing instructions loaded into the RAM 201 from the ROM 202, from an external memory (not shown), from a storage medium, or from a communication network. When the processing module 20 is powered up, the processor 200 is capable of reading instructions from the RAM 201 and executing them. These instructions form a computer program causing, for example, the implementation by the processor 200 of an ITM process comprising the processes described in relation to FIGS. 3, 4 and 5.

All or some of the algorithms and steps of these processes may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

FIG. 2C illustrates a block diagram of an example of the video decoder 13 in which various aspects and embodiments are implemented.

Video decoder 13 can be embodied as a device including various components or modules and is configured to receive a bitstream representative of an encoded HDR video content and to generate a decoded HDR video content. Examples of such system include, but are not limited to, various electronic systems such as a personal computer, a laptop computer, a smartphone, a tablet or a set top box. Components of the video decoder 13, singly or in combination, can be embodied in a single integrated circuit (IC), multiple ICs, and/or discrete components. For example, in at least one embodiment, the video decoder 13 comprises one processing module 20 that implements a video decoding process adapted to HDR video contents. In various embodiments, the video decoder 13 is communicatively coupled to one or more other systems, or other electronic devices, via, for example, a communications bus or through dedicated input and/or output ports.

The input to the processing module 20 can be provided through various input modules as indicated in block 22. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 2C, include composite video.

In various embodiments, the input modules of block 22 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting the video decoder 13 to other electronic devices across USB and/or HDMI connections. It is to be understood that various aspects of input processing, for example, Reed-Solomon error correction, can be implemented, for example, within a separate input processing IC or within the processing module 20 as necessary. Similarly, aspects of USB or HDMI interface processing can be implemented within separate interface ICs or within the processing module 20 as necessary. The demodulated, error corrected, and demultiplexed stream is provided to the processing module 20.

Various elements of the video decoder 13 can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards. For example, in the video decoder 13, the processing module 20 is interconnected to other elements of said the video decoder 13 by the bus 205.

The communication interface 204 of the processing module 20 allows the video decoder 13 to communicate on the communication network 21. The communication network 21 can be implemented, for example, within a wired and/or a wireless medium.

Data is streamed, or otherwise provided, to the video decoder 13, in various embodiments, using a wireless network such as a Wi-Fi network, for example IEEE 802.11 (IEEE refers to the Institute of Electrical and Electronics Engineers). The Wi-Fi signal of these embodiments is received over the communications network 21 and the communications interface 204 which are adapted for Wi-Fi communications. The communications network 21 of these embodiments is typically connected to an access point or router that provides access to external networks including the Internet for allowing streaming applications and other over-the-top communications. Still other embodiments provide streamed data to the video decoder 13 using the RF connection of the input block 22. As indicated above, various embodiments provide data in a non-streaming manner, for example, when the video decoder 13 is a smartphone or a tablet. Additionally, various embodiments use wireless networks other than Wi-Fi, for example a cellular network or a Bluetooth network.

The video decoder 13 can provide an output signal to various output devices using the communication network 21 or the bus 205. For example, the video decoder 13 can provide a decoded HDR signal.

The video decoder 13 can provide an output signal to various output devices, including the display device 14, speakers 26, and other peripheral devices 27. The display device 14 of various embodiments includes one or more of, for example, a touchscreen display, an organic light-emitting diode (OLED) display, a curved display, and/or a foldable display. The display device 14 can be for a television, a tablet, a laptop, a smartphone (mobile phone), or other devices. The display device 14 can also be integrated with other components (for example, as in a smartphone or a tablet), or separate (for example, an external monitor for a laptop). The display device 14 is HDR contents compatible. The other peripheral devices 27 include, in various examples of embodiments, one or more of a stand-alone digital video disc (or digital versatile disc) (DVR, for both terms), a disk player, a stereo system, and/or a lighting system. Various embodiments use one or more peripheral devices 27 that provide a function based on the output of the video decoder 13. For example, a disk player performs the function of playing the output of the video decoder 13.

In various embodiments, control signals are communicated between the video decoder 13 and the display device 14, speakers 26, or other peripheral devices 27 using signaling such as AV.Link, Consumer Electronics Control (CEC), or other communications protocols that enable device-to-device control with or without user intervention. The output devices can be communicatively coupled to video decoder 13 via dedicated connections through respective interfaces. Alternatively, the output devices can be connected to the video decoder 13 using the communication network 21 via the communication interface 204. The display device 14 and speakers 26 can be integrated in a single unit with the other components of the video decoder 13 in an electronic device such as, for example, a television. In various embodiments, the display interface includes a display driver, such as, for example, a timing controller (T Con) chip.

The display device 14 and speakers 26 can alternatively be separate from one or more of the other components, for example, if the RF module of input 22 is part of a separate set-top box. In various embodiments in which the display device 14 and speakers 26 are external components, the output signal can be provided via dedicated output connections, including, for example, HDMI ports, USB ports, or COMP outputs.

FIG. 2B illustrates a block diagram of an example of the system A adapted to implement the ITM module and/or the video encoder 12 in which various aspects and embodiments are implemented.

System A can be embodied as a device including the various components and modules described above and is configured to perform one or more of the aspects and embodiments described in this document.

Examples of such devices include, but are not limited to, various electronic devices such as personal computers, laptop computers, a camera, a smartphone and a server. Elements or modules of system A, singly or in combination, can be embodied in a single integrated circuit (IC), multiple ICs, and/or discrete components. For example, in at least one embodiment, the system A comprises one processing module 20 that implement the ITM module 11 and another processing module 20 that implements the video encoder 12. In various embodiments, the system A is communicatively coupled to one or more other systems, or other electronic devices, via, for example, a communications bus or through dedicated input and/or output ports.

The input to the processing module 20 can be provided through various input modules as indicated in block 22 already described in relation to FIG. 2C.

Various elements of system A can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards. For example, in the system A, the processing module 20 is interconnected to other elements of said system A by the bus 205.

The communication interface 204 of the processing module 20 allows the system A to communicate on the communication network 21. The communication network 21 can be implemented, for example, within a wired and/or a wireless medium.

Data is streamed, or otherwise provided, to the system A, in various embodiments, using a wireless network such as a Wi-Fi network, for example IEEE 802.11 (IEEE refers to the Institute of Electrical and Electronics Engineers). The Wi-Fi signal of these embodiments is received over the communications network 21 and the communications interface 204 which are adapted for Wi-Fi communications. The communications network 21 of these embodiments is typically connected to an access point or router that provides access to external networks including the Internet for allowing streaming applications and other over-the-top communications. Still other embodiments provide streamed data to the system A using the RF connection of the input block 22. As indicated above, various embodiments provide data in a non-streaming manner.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, smartphones (cell phones), portable/personal digital assistants (“PDAs”), tablets, and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations or embodiments can produce a variety of signals formatted to carry information that can be, for example, stored or transmitted. The information can include, for example, instructions for performing a method, or data produced by one of the described implementations or embodiments. For example, a signal can be formatted to carry a HDR video content of a described embodiment. Such a signal can be formatted, for example, as an electromagnetic wave (for example, using a radio frequency portion of spectrum) or as a baseband signal. The formatting can include, for example, encoding a HDR video content in an encoded stream (or bitstream) and modulating a carrier with the encoded stream. The information that the signal carries can be, for example, analog or digital information. The signal can be transmitted over a variety of different wired or wireless links, as is known. The signal can be stored on a processor-readable medium.

FIG. 3 illustrates an inverse tone mapping (ITM) process of an embodiment. The ITM process of FIG. 3 is typically applied by the ITM module 11. The process of FIG. 3 is for instance implemented by the processing module 20 of the ITM module 11 (or of the system A when the system A implements the ITM module 11) detailed later in relation to FIG. 2A.

In a step 31, the processing module 20 obtains SDR video data. In general, the SDR video data are in YUV format.

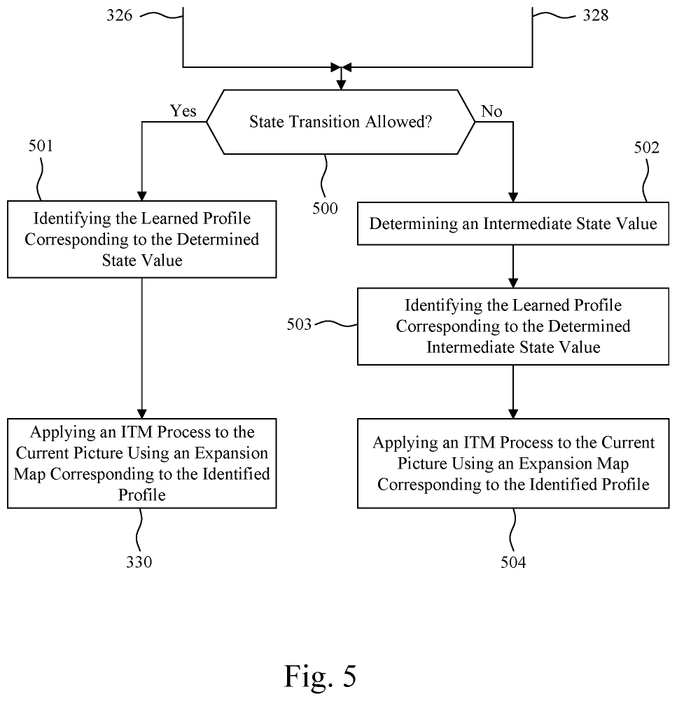

In a step 32, the processing module analyzes the SDR input data, computes the most appropriate Inverse Tone Mapping (ITM) function using the result of the analysis and outputs HDR video data using this ITM function. The ITM function is used to define the ITM process applied to the SDR video data to obtain the outputted HDR video data. The ITM function is for example, the ITM function of equation (1) or equation (2) and comprises therefore and expansion function G. FIGS. 4 and 5 illustrates two embodiments of a method for determining an expansion function G.

In addition, similarly to the method of document EP3249605, the method uses a set of profiles forming a template. In an embodiment, these profiles are determined in an offline learning phase. Each profile is defined by a visual feature and associated to an expansion function. However, as will be explained in relation to FIG. 4, the visual feature is no more an histogram of luminance values but a simpler information representative of an histogram of luminance values called state value.

As detailed in the following, a state value of a picture (or of a set of pictures) is defined by a position of at least one most representative bin of a simplified histogram of the picture (or set of pictures). During the learning phase, the profiles are determined from a large number of reference pictures that are manually graded by colorists, who manually set ITM parameters and generate the expansion functions (i.e. expansion maps) for these pictures. Then, the reference pictures are clustered based on state values. To do so, all reference pictures having the same state value are clustered in the same cluster. Each cluster is then processed in order to extract an expansion function associated to this cluster. To do so, an inter-picture distance is defined as the quadratic error of the expansion functions associated to the two pictures, limited to a support of the at least one most representative bin. Inside a cluster, for each picture of the cluster, the inter-picture distances between this picture and all other pictures of the cluster are accumulated. The picture with the lowest accumulated distance (i.e. approximately the picture the closest to all other pictures of the cluster) is considered as the picture representative of the cluster, and its expansion function becomes the expansion function associated to the cluster. In an embodiment, a sufficient diversity of the reference pictures guarantees that one cluster is associated to any possible state value.

As explained in the following in relation to FIG. 4 or 5, when a new SDR content is obtained, a state value of this new SDR content is computed. The computed state value is compared to the state value of each profile of the template, in order to find the state value of the template matching the best with the state value extracted from the new SDR content, i.e. in order to find the profile corresponding to the new SDR content. Then, the expansion function corresponding to the matching state value (i.e. to the selected profile) is selected. This selected expansion function is then used to inverse tone map the picture of the new SDR content and to obtain corresponding HDR pictures.

FIG. 4 illustrates schematically a first example of a process for determining an expansion function. The process of FIG. 4 is comprised in step 32 and is implemented by the processing module 20 of the ITM module 11 or by the processing module 20 of the system A.

In a step 321, the processing module 20 obtains a current SDR picture of a SDR video content.

In a step 322, the processing module 20 computes a first histogram of the current SDR picture. The first histogram comprises a first number of bins. A bin associates a sample value to a number of occurrences of the sample value in the current SDR picture. In an embodiment, the first number of bins NB1 is equal to “256” if it is considered that the SDR video content comprises “8” bits data.

In a step 323, the processing module 20 computes a second histogram representative of the first histogram with a second number of bins NB2 less than the first number of bins NB1. In an embodiment, the second number of bins NB2 is equal to “4”.

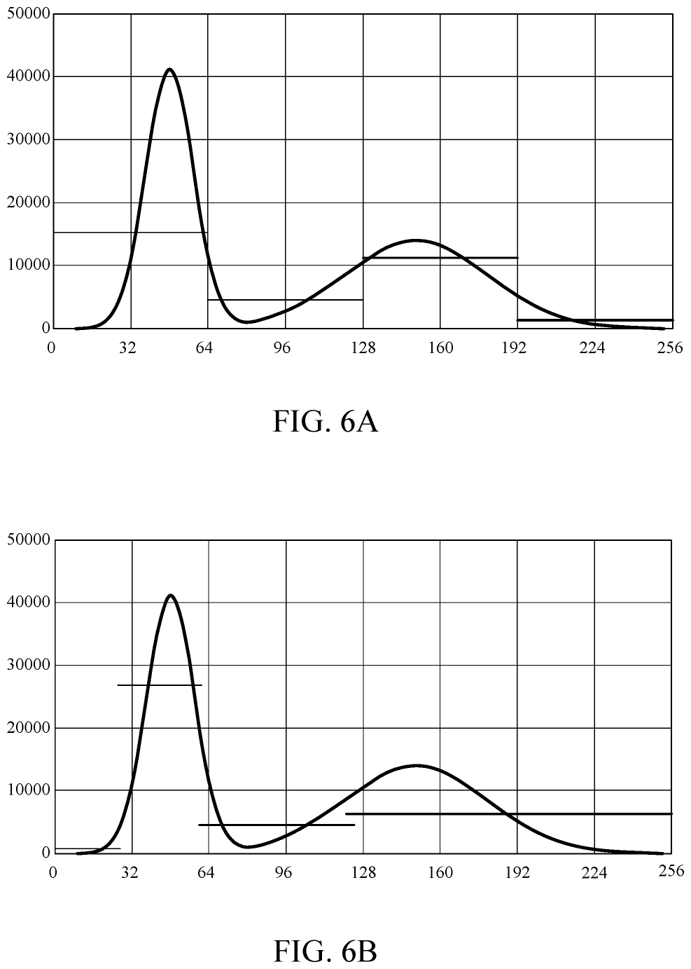

In an embodiment, the process of reducing the number of bins consists in segmenting the first histogram in NB2 non-overlapping segments of equal size (equal to 64 when NB2 is equal to 4) as represented in FIG. 6A. Here a segment corresponds to a bin of the second histogram. The number of occurrences associated to each segment is the number of occurrences of the samples values of the first histogram falling in this segment.

In an embodiment, the process of reducing the number of bins consists in segmenting the first histogram in NB2 non-overlapping segments of unequal sizes as represented in FIG. 6B. The size of the NB2 segments is for instance predefined. The number of occurrences associated to each segment is the number of occurrences of the sample values of the first histogram falling in this segment.

In an embodiment, the process of reducing the number of bins consists in segmenting the first histogram in NB2 overlapping segments of equal size (equal for example to “80”). The number of occurrences associated to each segment is the number of occurrences of the samples values of the first histogram falling in this segment.

In an embodiment, the process of reducing the number of bins consists in segmenting the first histogram in NB2 overlapping segments of unequal size. The size of the NB2 segments is for instance predefined. The number of occurrences associated to each segment is the number of occurrences of the samples values the first histogram falling in this segment.

In an embodiment, when a sample value appears in an overlapping part of two segments, the corresponding occurrence value of this sample value is weighted. The weighting consists for example in dividing the occurrence value associated to this sample value by two or in weighting the occurrence value associated to this sample value in function of the distance of the sample value to the middle of the segment.

In a step 324, the processing module 20 determines a current state value representative of the current SDR picture from at least one most representative bin of the second histogram, the most representative bin being the bin (i.e. the segment) of the second histogram representing the highest number of samples of the current SDR picture. The state value corresponds to a visual feature of the current SDR picture and is represented by the position(s) of the at least one most representative bin in the second histogram. For instance, the positions of the bins are defined from the left part to the right part of the second histogram from “0” to “3”.

In a first variant not represented in FIG. 4, only one most representative bin of the second histogram is used to represent the current state value of the current SDR picture. When NB2=4, the possible state values are (0), (1), (2) and (3). In this embodiment, step 324 is followed directly by a step 329.

In a second variant represented in FIG. 4, the current state value is represented by only one most representative bin of the second histogram when the number of samples represented by this most representative bin (i.e. when the number of occurrences of luminance values falling in this most representative bin) is higher than a threshold TH. When the number of samples represented by this most representative bin is lower than or equal to the threshold TH, the current state value is represented by two most representative bins of the second histogram: a first most representative bin corresponding to the bin (i.e. the segment) of the second number of bins representing the highest number of samples of the current SDR picture and second most representative bin corresponding to the bin of the second number of bins representing the second highest number of samples of the current SDR picture. In an embodiment, TH=70%. When NB2=4, the possible state values are (0), (1), (2), (3), (0,1), (0,2), (0,3), (1,0), (1,2), (1,3), (2,0), (2,1), (2,3), (3,0), (3,1), (3,2).

In the second variant, in step 324, the processing module 20 determines the most representative bin of the second histogram.

In a step 325, the processing module 20 determines if the number of samples represented by the most representative bin is higher than TH.

If yes, step 325 is followed by a step 326 during which the processing module 20 determines the current state value from the position of the most representative bin.

Otherwise, step 325 is followed by a step 327 during which the processing module 20 determines a second most representative bin.

In a step 328, the processing module 20 determines the current state value from the position of the first most representative bin and the position of the second most representative bin.

Steps 326 and 328 are followed by step 329.

In step 329, the processing module 20 determines the profile corresponding to the determined current state value in the set of profiles defined during the offline learning phase. As already indicated above, each profile of the set is associated to an expansion function.

In a step 330, the processing module 20 applies an inverse tone mapping to the current SDR picture using the expansion function associated with the identified profile to obtain a HDR picture.

In an embodiment, when the first most representative bin is similar to another bin, the expansion function is obtained by filtering/combining the expansion functions attached to each candidate state value. For instance, if both bins “0” and “1” contain each 35% of the samples of the current SDR picture, the candidate state values are (0,1) and (1,0). The expansion function G is obtained by filtering the expansion functions G_{(0,1)} and G_{(1,0)} attached to these candidate state values. The filtering consists, for example, in a weighted sum of the two expansion functions:

$$G = \frac{{G}_{( 0 , 1 )} + {G}_{( 1 , 0 )}}{2} .$$

The same situation may occur for the second most representative bin. In another example, the candidate state values can be (0,1), (0,2) and (0,3). The expansion function is obtained by filtering the expansion functions attached to these state values:

$$G = \frac{{G}_{( 0 , 1 )} + {G}_{( 0 , 2 )} + {G}_{( 0 , 3 )}}{3} .$$

In an embodiment, transitions between consecutive state values are controlled, in particular, for consecutive pictures for which no scene cut has been detected. A goal of this embodiment is to prevent transitions between state values which are very far from each other.

For instance, for two consecutive pictures t and t+1, a transition from state value (0) of picture t to state value (3,2) of picture t+1 is forbidden. This transition would correspond to a dark picture with dominating presence of low luminance values followed by a very bright picture. To prevent a sudden variation of the expansion function, in such cases, an intermediate state value is inserted. In this example, a modified sequence of state values [(0), (0,3), (3,2)] generates a more graceful transition of the expansion functions than the original sequence of state values [(0), (3,2)]. In this example, the state value (0,3) is given to picture t+1 and, if transition from state value (0,3) to state value (3,2) is allowed, the state value (3,2) is given to a picture t+2 following picture t+1. If the transition is not allowed, the process of identifying an intermediate state value is applied to picture t+2.

A general case of intermediate state values insertion is depicted in Table TAB1. In table TAB1, an initial state value (i.e. the state value of the SDR picture preceding the current SDR picture) is defined either by an index (i) or by indices (j,k). A current state value (i.e. the state value of the current SDR picture) is defined either by indices p and q with either p≠i≠q or j≠p≠k and j≠q≠k.

TABLE TAB1

| | | | |
|---|---|---|---|
| Previous | Current | Intermediate | Intermediate |
| state value | state value | state value 0 | state value 1 |

| | | | | | | | |
|---|---|---|---|---|---|---|---|
| i | — | i | — | | | | |
| | | p | i | i | p | | |
| | | p | q | i | p | p | i |
| | | p | — | i | p | p | i |
| j | k | j | k | | | | |
| | | k | j | | | | |
| | | j | — | | | | |
| | | k | — | k | j | | |
| | | j | p | | | | |
| | | k | p | k | j | | |
| | | p | j | j | p | | |
| | | p | k | k | j | k | p |
| | | p | — | j | p | p | j |

In table TAB1:
when the state value of the picture t is i and the state value of picture t+1 is i, no intermediate state value is required;
when the state value of the picture t is i and the state value of picture t+1 is (p,i), one intermediate state value is required and is equal to (i,p). State value (i,p) is given to picture t+1 and state value (p,i) is given to picture t+2;
when the state value of the picture t is i and the state value of picture t+1 is (p,q), two intermediate state values are required and are equal respectively to (i,p) and (p,i). State value (i,p) is given to picture t+1, state value (p,i) is given to picture t+2 and state value (p,q) is given to picture t+3;
when the state value of the picture t is i and the state value of picture t+1 is (p), two intermediate state values are required and are equal respectively to (i,p) and (p,i). State value (i,p) is given to picture t+1, state value (p,i) is given to picture t+2 and state value (p,q) is given to picture t+3;
etc.

FIG. 5 illustrates schematically a second example of a process for determining an expansion function based on the intermediate state values. Steps of the process of FIG. 5 are executed after steps 321 to 328 of FIG. 4. Steps 326 and 328 are followed by a step 500.

During step 500, the processing module 20 determines if the transitions between the state value of the SDR picture preceding the current SDR picture and the state value of the current SDR picture is allowed. To do so, the processing module 20 uses the table TAB1.

If the transition is allowed, step 501 corresponding to step 329 is applied by the processing module 20. Step 501 is followed by step 330 already explained.

If the transition is not allowed, during a step 502, the processing module 20 determines at least one intermediate state value based on the table TAB1.

In a step 503, the processing module 20 determines the profile corresponding to each determined intermediate state value in the set of profiles defined during the offline learning phase. As already indicated above, each profile of the set is associated to an expansion function.

In a step 504, the processing module 20 applies an inverse tone mapping to the current SDR picture (and eventually to SDR pictures following the current SDR picture) using the expansion function(s) associated with the profile(s) identified in step 503. If one intermediate state value was determined, the processing module 20 applies an inverse tone mapping to the current SDR picture using the expansion function corresponding to the intermediate state value and applies an inverse tone mapping to the SDR picture following the current SDR picture using the expansion function corresponding to the state value of the current SDR picture. If two intermediate state values were determined, the processing module 20 applies an inverse tone mapping to the current SDR picture using the expansion function corresponding to the first intermediate state value, applies an inverse tone mapping to the SDR picture following the current SDR picture using the expansion function corresponding to the second state value and applies an inverse tone mapping to the next SDR picture using the expansion function corresponding to the state value of the current SDR picture.

In an embodiment, instead of replacing the real state value of a SDR picture by a state value derived from table TAB1, the real state value and the derived state value are used to derive expansion functions. For example, when the state value of the SDR picture t is i and the state value of SDR picture t+1 is (p,i):
the expansion function G_{(i,p)} associated to the state value (i,p) (i.e. the intermediate state value derived from table TAB1) is combined with the expansion function G_{(p,i)} associated to the state value (p,i) (i.e. the real state value of SDR picture t+1) and the combined expansion function Gₜ₊₁ is applied to SDR picture t+1.
The expansion function G_{(p,i)} associated to the state value (p,i) (i.e. the real state value of picture t+1) is combined with the expansion function G_{(x,y)} associated to a state value (x,y) (i.e. the real state value of SDR picture t+2) and the combined expansion function Gₜ₊₂ is applied to SDR picture t+2.

In an embodiment, the combination of two expansion functions consists in computing the average of the two expansion functions. For example,

$${G}_{t + 1} = \frac{{G}_{( i , p )} + {G}_{( p , i )}}{2} and {G}_{t + 2} = \frac{{G}_{( p , i )} + {G}_{( x , y )}}{2} .$$

In some cases, the use of intermediate state values is not sufficient to ensure smooth transitions between successive expansion functions. In order to further ensure smooth transitions between successive expansion functions, in an embodiment, a temporal filtering is applied to expansion functions of successive SDR pictures. In that case, the expansion function Gₜ applied to a current SDR picture t is a weighted sum of the expansion function G_{(x,y)} determined from the state value (x,y) of the current SDR picture t and expansion functions Gₜ₋ₙ of SDR picture(s) t−n preceding the current SDR picture t:

$${G}_{t} = w \cdot {G}_{( x , y )} + {\sum }_{n = 1}^{N} {w}_{n} \cdot {G}_{t - n}$$

where N is a time constant ≥1 and w+Σₙ₌₁^{N} wₙ=1. The time constant N is either fixed or dependent on an average distance between two consecutive different state values in the SDR video content. For example, for N=1 et w₁=1−w:

$${G}_{t} = w \cdot {G}_{( x , y )} + ( 1 - w ) \cdot {G}_{t - 1}$$

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described HDR pictures, or variations thereof.
Creating and/or transmitting and/or receiving and/or decoding a bitstream or signal that includes one or more of the described HDR pictures, or variations thereof.
A server, camera, TV, set-top box, cell phone, tablet, personal computer or other electronic device that performs at least one of the embodiments described.
A TV, set-top box, cell phone, tablet, personal computer or other electronic device that performs at least one of the embodiments described, and that displays (e.g. using a monitor, screen, or other type of display) a resulting picture.

A TV, set-top box, cell phone, tablet, personal computer or other electronic device that tunes (e.g. using a tuner) a channel to receive a signal including encoded HDR pictures, and performs at least one of the embodiments described.
A TV, set-top box, cell phone, tablet, or other electronic device that receives (e.g. using an antenna) a signal over the air that includes HDR pictures, and performs at least one of the embodiments described.
A server, camera, cell phone, tablet, personal computer or other electronic device that tunes (e.g. using a tuner) a channel to transmit a signal including HDR pictures, and performs at least one of the embodiments described.
A server, camera, cell phone, tablet, personal computer or other electronic device that transmits (e.g. using an antenna) a signal over the air that includes HDR pictures, and performs at least one of the embodiments described.

1-15. (canceled)

16. A method comprising:
obtaining a first histogram of a current standard dynamic range (SDR) picture, the first histogram comprising a first number of bins, a bin associating a sample value to a number of occurrences of the sample value in the current SDR picture;
determining a first most representative bin representative of the current SDR picture from the first histogram, the first most representative bin being the bin of the first histogram representing a highest number of samples of the current SDR picture;
determining a first state value based on the determined first representative bin;
determining that a transition between a previous state value and the first state value belongs to a set of allowed transitions, the previous state value being representative of a previous SDR picture preceding the current SDR picture;
responsive to the transition is belonging to the set of allowed transitions, applying an inverse tone mapping to the current SDR picture using an expansion function associated with a first profile of a plurality of profiles corresponding to the first state value to obtain a high dynamic range (HDR) picture, each profile of the plurality of profiles being associated to an expansion function; and
responsive to the transition not belonging to the set of allowed transitions, determining at least one intermediate state value from the set of allowed transitions, identifying a second profile of the plurality of profiles corresponding to a first determined intermediate state value, and applying an inverse tone mapping to the current SDR picture using an expansion function associated to the identified second profile to obtain the HDR picture.

17. The method of claim 1, wherein the first histogram is obtained from a second histogram of the current SDR picture comprising a second number of bins, the first number of bins being less than the seconds number of bins.

18. The method according to claim 1, wherein at least one second most representative bin is determined from the first histogram, a second most representative bin being a bin of the first histogram different from the most representative bin representing one of the highest number of samples of the current SDR picture, each determined most representative bin being used to identify determine the first state value.

19. The method of claim 1, comprising, responsive to at least one second intermediate state value is determined from the set of allowed transitions, identifying a third profile in the plurality of profiles for each second determined intermediate state value, and applying an inverse tone mapping to SDR pictures following the current SDR picture using expansion functions associated to each identified third profiles to obtain a corresponding HDR picture.

20. The method of claim 1, wherein the expansion function used for the inverse tone mapping of the current SDR picture is based on the expansion function associated to the first or second profile and on at least one expansion function determined for a SDR picture preceding the current SDR picture.

21. A device comprising electronic circuitry configured for:
obtaining a first histogram of a current standard dynamic range (SDR) picture, the first histogram comprising a first number of bins, a bin associating a sample value to a number of occurrences of the sample value in the current SDR picture;
determining a first most representative bin representative of the current SDR picture from the first histogram, the first most representative bin being the bin of the first histogram representing a highest number of samples of the current SDR picture;
determining a first state value based on the determined first representative bin;
determining that a transition between a previous state value and the first state value belongs to a set of allowed transitions, the previous state value being representative of a previous SDR picture preceding the current SDR picture;
responsive to the transition is belonging to the set of allowed transitions, applying an inverse tone mapping to the current SDR picture using an expansion function associated with a first profile of a plurality of profiles corresponding to the first state value to obtain a high dynamic range (HDR) picture, each profile of the plurality of profiles being associated to an expansion function; and
responsive to the transition not belonging to the set of allowed transitions, determining at least one intermediate state value from the set of allowed transitions, identifying a second profile of the plurality of profiles corresponding to a first determined intermediate state value, and applying an inverse tone mapping to the current SDR picture using an expansion function associated to the identified second profile to obtain the HDR picture.

22. The device of claim 6, wherein the first histogram is obtained from a second histogram of the current SDR picture comprising a second number of bins, the first number of bins being less than the second number of bins.

23. The device according to claim 6, wherein at least one second most representative bin of the first histogram is determined, the second most representative bin being a bin of the first histogram different from the most representative bin representing one of the highest number of samples of the current SDR picture, each determined most representative bin being used to determine the state value.

24. The device of claim 8, wherein, responsive to at least one second intermediate state value is determined from the set of allowed transitions, the electronic circuitry is further configured for identifying a third profile in plurality of profiles for each second determined intermediate state value, and applying an inverse tone mapping to SDR pictures following the current SDR picture using expansion functions associated to the identified third profiles to obtain the HDR pictures.

25. The device of claim from claim 6, wherein the expansion function used for the inverse tone mapping of the current SDR picture is based on the expansion function associated to the first or second profile and on at least one expansion function determined for a SDR picture preceding the current SDR picture.

26. Non-transitory information storage medium storing program code instructions for implementing the method according to claim 16.

27. Non-transitory information storage medium storing program code instructions for implementing the method according to claim 17.

28. Non-transitory information storage medium storing program code instructions for implementing the method according to claim 18.

29. Non-transitory information storage medium storing program code instructions for implementing the method according to claim 19.

30. Non-transitory information storage medium storing program code instructions for implementing the method according to claim 20.
